(19) United States
(12) Patent Application Publication
(10) Pub. No.: US 2024/0319982 A1
(43) Pub. Date: Sep. 26, 2024

(54) UPDATE METHOD AND DEVICE

(71) Applicant: Lenovo (Beijing) Limited, Beijing (CN)

(72) Inventors: Yansheng DONG, Beijing (CN); Yangyang ZHU, Beijing (CN)

(21) Appl. No.: 18/606,655

(22) Filed: Mar. 15, 2024

(30) Foreign Application Priority Data
Mar. 22, 2023 (CN) 202310284441.8

(51) Int. Cl. G06F 8/65; G06F 8/71

(52) U.S. Cl. CPC G06F 8/65; G06F 8/71

(57) ABSTRACT

An update method includes: in response to determining that update information exists for a first component and/or a second component of an electronic device, obtaining target update data for the second component of the electronic device; and updating the second component based on the target update data to cause the second component to provide a target function or realize the target function through the second component, where the target update data has an association relationship with the update information.

### CROSS-REFERENCES TO RELATED APPLICATION

This application claims priority to Chinese Patent Application No. 202310284441.8 filed on Mar. 22, 2023, the entire content of which is incorporated herein by reference.

### FIELD OF TECHNOLOGY

The present disclosure relates to the field of computer technology and, more specifically, to an update method and device.

### BACKGROUND

Before an electronic device leaves the factory, some customized functions are often set in the pre-installed operating system of the electronic device to improve the performance of the electronic device or improve the user's ease of operation.

These customized functions may be related to the operating system, BIOS program or other components in the electronic device. Therefore, after the electronic device leaves the factory, if the user reinstalls a new operating system, a BIOS program or other components in the electronic device that causes a change, the normal use of some customized functions may be affected. In some cases, the customized functions may become unavailable.

### SUMMARY

One aspect of this disclosure provides an update method. The method includes, in response to determining that update information exists for a first component and/or a second component of an electronic device, obtaining target update data for the second component of the electronic device; and updating the second component based on the target update data to cause the second component to provide a target function or realize the target function through the second component. The target update data has an association relationship with the update information.

Another aspect of the present disclosure provides an update device. The device includes a data acquisition unit and a component update unit. The data acquisition unit is configured to, in response to determining that update information exists for a first component and/or a second component of an electronic device, obtain target update data of the second component of the electronic device. The component update unit is configured to update the second component based on the target update data to cause the second component to provide a target function or realize the target function through the second component. The target update data has an association relationship with the update information.

Another aspect of the present disclosure provides a non-transitory computer-readable storage medium containing computer-executable instructions for, when executed by one or more processors, performing an update method. The method includes, in response to determining that update information exists for a first component and/or a second component of an electronic device, obtaining target update data for the second component of the electronic device; and updating the second component based on the target update data to cause the second component to provide a target function or realize the target function through the second component. The target update data has an association relationship with the update information.

### BRIEF DESCRIPTION OF THE DRAWINGS

In order to illustrate the technical solutions in accordance with the embodiments of the present disclosure more clearly, the accompanying drawings to be used for describing the embodiments are introduced briefly in the following. It is apparent that the accompanying drawings in the following description are only some embodiments of the present disclosure. Persons of ordinary skill in the art can obtain other accompanying drawings in accordance with the accompanying drawings without any creative efforts.

FIG. 1 is a flowchart of an update method according to an embodiment of the present disclosure.

FIG. 2 is a flowchart of the update method according to an embodiment of the present disclosure.

FIG. 3 is a flowchart of the update method according to an embodiment of the present disclosure.

FIG. 4 is a flowchart of the update method according to an embodiment of the present disclosure.

FIG. 5 is a schematic structural diagram of an update device according to an embodiment of the present disclosure.

FIG. 6 is a schematic structural diagram of an electronic device according to an embodiment of the present disclosure.

### DETAILED DESCRIPTION

Technical solutions of the present disclosure will be described in detail with reference to the drawings. It will be appreciated that the described embodiments represent some, rather than all, of the embodiments of the present disclosure. Other embodiments conceived or derived by those having ordinary skills in the art based on the described embodiments without inventive efforts should fall within the scope of the present disclosure.

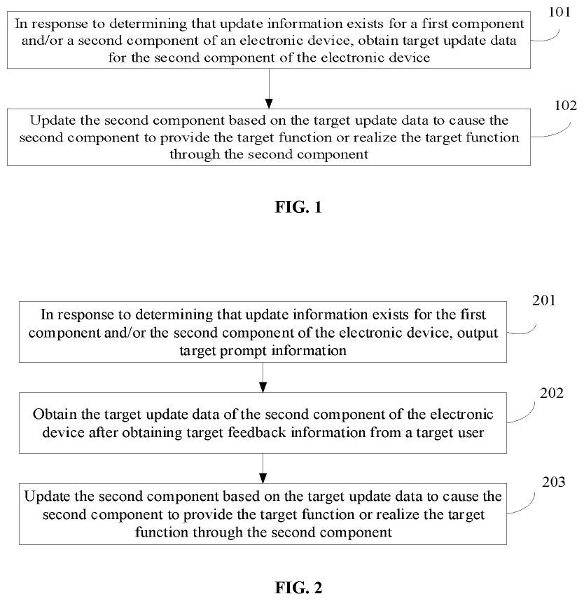

FIG. 1 is a flowchart of an update method according to an embodiment of the present disclosure. The update method can be applied to electronic devices, which can be mobile phones, laptops, tablets, desktop computers, servers, etc., which is not limited in the embodiments of the present disclosure. The update method will be described in detail below.

101, in response to determining that update information exists for a first component and/or a second component of an electronic device, obtaining target update data for the second component of the electronic device.

In the embodiments of the present disclosure, the first component and the second component may be components in the electronic device that can affect customized functions configured in the electronic device. In some embodiments, the customized functions configured I the electronic device may be implemented through the second component. The first component and the second component may be software program modules or hardware modules, which is not limited in the embodiments of the present disclosure.

For example, the first component may be a basic input output system (BIOS), a unified extensible firmware interface (UEFI), a trusted platform module (TPM) or an AI chip (also referred to as an AI accelerator or a computing card) in the electronic device.

The second component may be an operating system, an application program that supports customized services, or a firmware program in the hardware, etc., which is not limited in the embodiments of the present disclosure.

In the present disclosure, the existence of the update information in at least one of the first component and the second component will affect some customized functions in the electronic device that need to be implemented by the second component, such as causing the customized function to be abnormal or unavailable, etc.

In some embodiments, the target update data may be data used to update the second component such that the second component can provide or realize the target function.

It should be understood that due to difference update information in the first component and/or the second component, the customized functions affected will also be different, and the target update data required by the update function will also be different. Therefore, the target update data may have a correlation relationship with the update information existing in the first component and/or the second component.

It should be understood that determining that the update information exists for the first component and/or the second component at the process at 101 may be performed each time the electronic device is turned on or restarted, or performed according to a set detection cycle. When the detection time is reached, whether the update information exists in the first component and/or the second component may be determined such that the target update data can be obtained in response to the update information.

Of course, real-time monitoring may be performed to determine whether the update information exists in the first component and/or the second component. If the update information is detected, an operation of obtaining the target update data may be performed in response to determining that the update information exists, which is not limited in the embodiments of the present disclosure.

102, updating the second component based on the target update data to cause the second component to provide the target function or realize the target function through the second component.

In some embodiments, the target function may refer to the function that needs to rely on the second component and is affected by the existence of the updated information in the first component and/or the second component. For example, the target function may belong to a pre-configured customized function in the electronic device, and is a customized function that is unavailable due to an update of the first component and/or the second component.

In some embodiments, the target update data may set the code data of the target function in the second component, or enable the second component to have the required configuration data and configuration method of the target update data, which is not limited in the embodiments of the present disclosure. Correspondingly, the affected target function in the electronic device can be restored by updating the second component based on the target update data.

It should be understood that in the present disclosure, a management program may be separately set in the electronic device. The management program may be used to execute the update method of the present disclosure to update the second component based on the target update data when the update information exists for the first component and/or the second component.

In the present disclosure, the update method may also be executed through the first component.

Of course, the update method may also be executed by the first component and the management program configuration, which is not limited in the embodiments of the present disclosure.

Consistent with the present disclosure, in the case where the update information of the first component or the second component of the electronic device affects a certain customized function in the electronic device, the target update data of the second component can be obtained. The target update data can be used to update the second component to cause the second component to provide or realize the corresponding functions, thereby reducing the situation where the customized functions are affected or the customized functions are unavailable due to the presence of the update information in certain components of the electronic device.

In order to facilitate the understanding of the possible situations in the present disclosure, situations that can affect the customized functions in the electronic device and need to trigger the acquisition of the target update data to update the second component, several possible situations related to determining that the update information exists for the first component and/or the second component are described below.

For example, determining that the update information exists for the first component and/or the second component may include at least one of the following three possible situations.

In the first situation, in response to determining that correspondence information between the first component and the second component of the electronic device does not match, determining that first update information exists for the first component and/or second update information exists for the second component.

In some embodiments, the mismatch in correspondence information between the first component and the second component may be that the version information between the first component and the second component does not match. For example, the current version information of the first component and the current version information of the second component do not belong to the version information that adapts to each other or establishes a binding association.

Take the first component as the BIOS program and the second component as the operating system as an example. When the electronic device is in the factory, some customized functions may be configured for the operating system, such as charging the power management or registry and other related functions for the operating system configuration. Some customized functions based on the operating system are closely related to the BIOS. Therefore, after the electronic device leaves the factory, if the BIOS program is updated, the operating system is reinstalled in the electronic device, or the version of the operating system is updated, the BIOS system and the operating system in the electronic device will not match the factory version, which will make some customized functions unable to be used normally or even completed unusable.

The mismatch between the correspondence information between the first component and the second component may also be a mismatch between the flag bit information in the first component and the function that the second component can provide or realize. In some embodiments, the flag bit information in the first component may be used to record at least one function that the second component can provide. Correspondingly, any version update or installation of the first component and the second component may lead to a mismatch between the flag bit information in the first component and the function that the second component can provide or realize.

Continue with the first component as the BIOS program and the second component as the operating system as an example. When some customized functions are set up for the operating system at the electronic device factory stage, the functions that the operating system can implement or provide can be recorded in the BIOS through flag bit information. After the electronic device leaves the factory, if the BIOS is updated, the flag bit information may change, which may cause the functions that can be implemented based on the operating system to be inconsistent with the flag bit information recorded in the BIOS. Alternatively, the BIOS may not have been updated, but the operating system has been reinstalled on the electronic device or the operating system has been upgraded. In this case, the updated operating system may not include the related customized functions, which makes the functions that the operating system can implement or provide inconsistent with the flag bit information in the BIOS.

Of course, there may be other arrangements for the mismatch of the correspondence information between the first component and the second component, which is not limited in the embodiments of the present disclosure.

As described above, when the correspondence information between the first component and the second component does not match, it may be that the first component has the update information, the second component has the update information, or both the first component and the second component have the update information.

In the present disclosure, for the convenience of distinction, the update information for the first component can be referred to as the first update information, and the update information for the second component can be referred to as the second update information.

Based on the possible mismatch between the first component and the second component, it can be seen that the first component having the first update information may include at least one of the following: the first component has version update information; the first component has flat update information, the flag bit update information being used to characterize the function item update information of the second component of the electronic device; there is a replacement record for a third component of the electronic device, the third component being used for the second component of the electronic device to achieve the target function.

In some embodiments, the replacement record of the third component of the electronic device may respond to the information update in the first component. For example, the third component may be a component related to the function recorded in the flag bit information in the first component. For example, the third component may cooperate with the third component to implement the function recorded in the flag bit information in the first component.

In some embodiments, the replacement record of the third component may be a new third component, or it may be a replacement of the third component with a stronger performance or expanded performance, which is not limited in the embodiments of the present disclosure.

Similarly, the second component having the second update information may include at least one of the following: the second component has version update information; the second component has loading information; there is a replacement record for the third component of the electronic device, the third component being used for the second component to achieve the target function.

For different possibilities such as whether the second component is software or hardware, the second component having the loading information may include: the second component having the hardware device assembly; downloading or uninstalling of software programs in the second component; or software reinstallation in the second component.

The third component may be used by the second component to achieve the target function. Therefore, updates to the third component may also lead to functional changes in the second component, causing update information for the second component.

In the second situation, in response to determining that the update information exists for the first component and/or the second component of the electronic device may be that: determining that the first update information exists for the first component in response to determining that the current information of the first component of the electronic device does not match the corresponding historical information.

In some embodiments, a mismatch between the current information of the first component and the corresponding historical information may indicate that there is an update to the first component.

In some embodiments, the mismatch between the current information of the first component and the corresponding historical information may be that the current version information of the first component is inconsistent with the historical version information of the first component before the current time of the electronic device, the current configuration information (e.g., the flag bit information) of the first component is inconsistent with the historical configuration information (e.g., the historical flag bit information), or other situations that affect the function of the second component, which is not limited in the embodiments of the present disclosure.

For example, the historical information of the first component may be stored in the management program in the electronic device. In another example, the management program may be configured to query the historical information of the first component stored in the target server, and then the management program may compare the current information of the second component with the historical information to determine whether there is a match.

In another example, the first component may be used to compare whether the current information of the first component matches the historical information of the first component stored in a set area (e.g., the historical information of the first component stored by the management program or other designated areas) of the electronic device.

It should be understood that in the second situation, for the case where the first update information exists in the first component, reference can be made to the foregoing description, which will not be repeated here.

In the third situation, in response to determining that the update information exists for the first component and/or the second component of the electronic device may be that: determining that the second update information exists for the second component in response to determining that the current information of the second component of the electronic device does not match the corresponding historical information.

In some embodiments, the mismatch between the current information of the second component and the corresponding historical information may be caused by the mismatch between the current version information of the first component and the historical version information, a mismatch between the firmware program information of the first component and the historical firmware program information, or a mismatch between the function information of the first component and the historical function information, which is not limited in the embodiments of the present disclosure.

The specific implementation of determining that the current information of the second component does not match the corresponding historical information may be to use the management program to compare the current information of the second component with the stored historical information of the second component or the historical information of the second component obtained from the target server. Alternatively, after the first component obtains the historical information of the second component through the management program or from the designated storage area of the electronic device, the current information of the second component can be obtained in real time to perform the comparison.

For the existence of the second update information on the second component, reference can be made to the foregoing description and will not be repeated here.

In some embodiments, to update the second component more reasonably when there is update information for the first component and/or the second component, in the present disclosure, a corresponding reminder may also be output before updating the second component, and the update of the second component may only be performed after the user confirms the update of the second component.

FIG. 2 is a flowchart of the update method according to an embodiment of the present disclosure.

201, in response to determining that update information exists for the first component and/or the second component of the electronic device, outputting target prompt information.

In some embodiments, the target prompt information may be used to remind the user whether to update the second component. For example, the target prompt information may prompt the user to confirm whether to update the second component or update the target function of the second component, etc.

There are many forms and output methods for the target prompt information, which are not limited in the embodiments of the present disclosure.

In some embodiments, the target prompt information may be output in a target manner, and the target manner may be determined with the update information of the first component and/or the second component.

In some embodiments, the target manner may be in the form of a prompt bar presenting the target prompt information with various changes in output channels, font types, and display effects (e.g., color, static or flashing, etc.).

There are also many possibilities for the correlation of the target manner with the update information.

For example, based on the difference in update information, the user demand for the target update data used to update the second component may be determined, and difference output methods may be set based on the different demand programs. Alternatively, based on different categories of the update information, the target manner for outputting the target prompt information may be determined based on the corresponding manners of the different categories.

For the update information on the first component and/or the second component, reference can be made to the relevant description in the foregoing embodiments, which will not be repeated here.

202, obtaining the target update data of the second component of the electronic device after obtaining target feedback information from a target user.

In some embodiments, the target feedback information of the target user may be the feedback information for the target prompt information, and the target feedback information may indicate that the target user agrees to update the second component.

In some embodiments, the target update data may have an association relationship with the update information of the first component and/or the second component.

203, updating the second component based on the target update data to cause the second component to provide the target function or realize the target function through the second component.

For the process at 203, reference can be made to the relevant description of the foregoing embodiments, which will not be repeated here.

In the embodiments of the present disclosure, the target prompt information will be output first when update information exists for the first component and/or the second component of the electronic device. In addition, the target update data of the second component will be obtained and the second component will be updated only after the target feedback information is obtained from the target user. Accordingly, obtaining the target update data and updating the second component can be prevented when the user does not need the second component to provide or realize the target function, thereby reducing unnecessary data processing and controlling the update of the second component more reasonably.

It should be understood that FIG. 2 is an example of outputting the target prompt information before obtaining the target update data.

In some embodiments, the target prompt information may be output after the target update data is obtained, and updating the second component based on the target update data may be performed after the target feedback information is obtained from the target user. In this case, the target update data can be obtained, and the target prompt information can be output once or multiple times as needed. Accordingly, when the user wants the second component to support the target function, the second component can be updated based on the target update data such that the second component can provide or realize the target function. In addition, in this case, the target prompt information can also be output in the target manner without any restrictions.

In any of the above embodiments of the present disclosure, there are many methods for obtaining the target update data of the second component of the electronic device, which are not limited in the embodiments of the present disclosure.

The following describes several situations in which target update data is obtained. The target update data that can be obtained in the present disclosure can be implemented in any of the following ways.

In some embodiments, when obtaining the target update data, target update data matching the update information existed in the first component and/or the second component may be requested from the target server.

In some embodiments, the target server may be a server designated in advance for storing update data required by the second component. Of course, the target server may also be used to store current information and historical information of the first component and the second component, etc., which is not limited in the embodiments of the present disclosure.

Take the management program executing the update method of the present disclosure as an example. The target server may be a server corresponding to the management program, and the server may store relevant data required for updating changes of the first component and the second component.

In some embodiments, when obtaining the target update data, an acquisition path of the target update data may be obtained based on release information of the target update data such that the target update data can be obtained based on the acquisition path.

In some embodiments, the release information of the target update data may include one or more of the identification information of the target update data, release time, release location, publisher, etc. In some embodiments, the release information of the target update data may be recorded in the flag bit information of the first component, or may be determined based on the update information of the first component and/or the second component, which is not limited in the embodiments of the present disclosure.

The acquisition path of the target update data may be obtained from the target server or edge device based on the release information of the target update data, or the number of target update data pushed in advance by the target server in the management program may be obtained, which is not limited in the embodiments of the present disclosure.

In some embodiments, when obtaining the target update data, the target update data of the second component pushed by the target server to the electronic device may be obtained.

For example, when the first component and/or the second component implements an updated version or other update changes through the target server such that the first component and/or the second component have update information, the target server may push the target update data of the second component corresponding to the update information to the electronic device, for example, to a management program in the electronic device.

Alternatively, after the target server detects the target update data published for the second component, the target update data may be pushed to the electronic device.

Of course, there are other ways for the target server to push the target update data to the electronic device, which is not limited in the embodiments of the present disclosure.

In some embodiments, when obtaining the target update data, the target update data of the second component may be obtained from an edge device that established a target communication connection with the electronic device. In this implementation method, the edge device that has established a communication connection with the electronic device may be used as a provider of the target update data such that the target update data can be obtained more reliably and efficiently.

For the specific process of obtaining the target update data from the edge device, reference can be made to the relevant description above, and will not be repeated here.

Of course, in practical applications, reference information such as the type, update time, description, and evaluation information of the target update data may also be combined to determine whether to obtain the target update data from the target or the edge device.

In any of the foregoing embodiments of the present disclosure, the obtained target update data may be the data required for the target function to provide or realize the target function, and the target function may be a function that is affected by the existence of the update information of the first component and/or the second component and needs to rely on the second component in the electronic device.

Based on this, in response to the existence of the update information on the first component and/or the second component, in the present disclosure, the affected target function in the electronic device may be determined first to obtain the target update data corresponding to the target function.

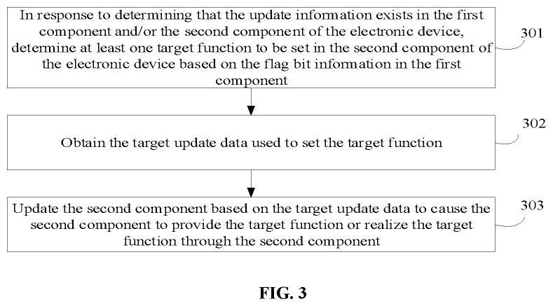

FIG. 3 is a flowchart of the update method according to an embodiment of the present disclosure. The method will be described in detail below.

301, in response to determining that the update information exists in the first component and/or the second component of the electronic device, determining at least one target function to be set in the second component of the electronic device based on the flag bit information in the first component.

In some embodiments, the flag bit information may be used to record at least one function that the second component can have. The target function may belong to the function recorded in the flag bit information.

In some embodiments, since the flag bit information records at least one function that the second component can have, the functions that the second component needs to support or provide may be determined based on the flag bit information, and these functions may be determined as target functions.

In some embodiments, in order to avoid excessive updates to the second component, the target function may be a function recorded in the flag bit information and a function that the second component cannot currently provide and realize. Based on this, since the flag bit information records at least one function that the second component can have, the functions that the second component can currently provide or realize may also be determined. By comparing the various functions recorded in the flag bit information with the functions that the second component can currently provide or realize, the functions recorded in the flag bit information can be determined as the target functions that the second component cannot currently provide or realize.

It should be noted that there may also be multiple methods for determining the functions that the second component can currently provide or realize.

Take the update information being executed through the management program in the electronic device as an example. The management program may read the flag bit information in the first component, and scan or analyze the second component to determine the flag bit information that the second component can currently support. The second component may also be configured with function record information for recording the functions that the second component can currently implement or provide. The management program may query the function record information to determine the functions that the electronic device can provide or realize.

Take the update information being executed by the first component in the electronic device as an example. The first component may read the flag bit information stored in the first component. In addition, the first component may read the function record identifier stored in the second component and determine the functions that the second component can currently implement or provide. Or, the first component may call the management program to analyze the second component and determine the functions that the second component can currently provide or realize.

Considering that the update information exists in the first component and/or the second component may be different, the implementation method of determining the target function to be set in the second component based on the flag bit information in the first component may also be different. Based on this, in the present disclosure, at least one target function to be set in the second component of the electronic device may also be determined based on the flag bit information in the first component and the update information.

In some embodiments, depending on the type of update information, one of the above two methods may be selected to determine the target function or the two methods may be combined to determine the target function.

More specifically, in the case where the update information is the first update information that exists in the first component, at least one new function added in the flag bit information of the first component may be determined, and the at least one function may be determined as the at least one target function to be set for the second component.

It should be understood that after the first component is updated, the flag bit information in the first component will record the new functions required by the electronic device due to the update of the first component. However, since the second component is not updated synchronously, due to reasons such as mismatch of the correspondence information between the first component and the second component, the new function may not be a function that the first component can currently provide or realize. Based on this, the new function may be determined as the target function to be set by the second component.

In some embodiments, at least one new function added to the flag bit information of the first component may be determined by comparing the current flag bit information of the first component with the historical flag bit information of the first component obtained from history through the management program. Alternatively, the new function recorded in the flag bit information of the first component may be determined by comparing the current version information of the first component with the historical version information of the first component, which is not limited in the embodiments of the present disclosure.

Correspondingly, in the case where the update information is the second update information that exists in the second component, at least one function recorded in the flag bit information of the first component may be determined to be the at least one target function to be set by the second component.

In some embodiments, if there is no update for the first component, but only update for the second component, then the version information and other corresponding information of the second component may not match the first component. Accordingly, the functions recorded in the flag bit information in the first component cannot be provided or implemented by the second component. Based on this, at least one function recorded in the flag bit information may be determined as the at least one target function to be set by the second component.

In practical applications, if the second update information of the second component causes the current information of the second component to change less compared to its historical information, it may only cause some functions to be unavailable. Based on this, in order to reduce the target update data obtained and reduce the update content of the second component, if the second update information is update information other than the reload information, the function that the second component can currently provide or realize may be detected, and the functions in the flag bit information may be compared with the functions that the second component can currently provide or realize to determine at least one target function in the flag bit information that is not provided or implemented by the second component.

In particular, when the update information exists for both the first component and the second component, the specific implementation method of determining the target function when the second update information exists for the second component may be used to determine the target function, which will not be repeated here.

Take the first component as the BIOS program and the second component as the operating system as an example. Of course, the same applies to the case where the first component is a UEFI or AI chip and the second component is other software programs. Before the electronic device leaves the factory, flag bit information can be stored in the BIOS. The flag bit information may record the function identifiers of various customized functions that the operating system can provide or realize.

Based on this, after the electronic device leaves the factory, if the BIOS is not updated and the operating system is reinstalled, the customized functions that were originally provided or implemented by the operating system will no longer exist. Based on this, the management program (or the BIOS program) may read the function identifiers of each function recorded in the flag bit information in the BIOS, and determine each function as the target function that needs to be configured in the operating system.

In some embodiments, if the operating system in the electronic device is only being upgraded instead of being reinstalled, the functions recorded by the flag bit information in the BIOS may be determined as the target functions using the method described above, or the functions that the operating system can currently provide or realize may be determined, and the functions included in the flag bit information that are not currently provided or implemented may be determined by the operating system as the target functions.

In some embodiments, if the operating system is not updated and the BIOS is updated, then if the electronic device can add some customized functions due to the BIOS update, the flag bit information in the updated IOBS may be updated. Based on this, the management program (or the BIOS program) may determine the function identifier of the new function in the updated flag bit information in the BIOS, and then determine the new function as the target function that the operating system needs to update.

In some embodiments, when both the operating system and BIOS are updated, the functions included in the flag bit information and not currently provided or implemented by the operating system may be determined as target functions.

302, obtaining the target update data used to set the target function.

In some embodiments, the target update data may have an association relationship with the update information.

In some embodiments, the target update data may be the data used to configure the target function for the second component.

For specific implementation of obtaining the target update data, reference can be made to the relevant description in the foregoing embodiments, which will not be repeated here.

For ease of understanding, the description will be given in combination with the several methods of obtaining the target update data described above.

In some embodiments, the update data corresponding to each function may be stored in the target server. Correspondingly, the target update data corresponding to the function identifier of the target function may be obtained from the target server based on the function identifier of the target function. The process of obtaining the target update data from the target server is also similar, which will not be repeated here.

In some embodiments, the flag bit information may also record the release information or acquisition path of the update data corresponding to each function. Based on this, the acquisition path of the target update data may be obtained from the target server based on the release information of the target update data corresponding to the target function, and the target update data may be obtained based on the acquisition path. Alternatively, the target update data may be directly obtained based on the acquisition path.

Of course, if the target server or edge device has pushed update data of at least one function to the electronic device, the target update data corresponding to the target function pushed by the target server or edge device may be directly obtained.

Similar to the previous embodiment, this embodiment can be executed through the management program or through the first component. More specifically, when it is needed to obtain the target update data from the target server or edge device, considering that the first component such as BIOS may not be able to communicate directly with the target server or edge device, when using the first component to obtain the target update data, the first component may obtain the target update data by calling the management program.

303, updating the second component based on the target update data to cause the second component to provide the target function or realize the target function through the second component.

For the specific process at 303, reference can be made to the relevant description in the foregoing embodiments, which will not be repeated here.

It should be understood that in this embodiment, before obtaining the target update data or updating the second component based on the target update data, the target prompt information may also be output. Based on this, the process of obtaining the target update data or updating the second component based on the target update data may only be performed after the target feedback information of the target user is obtained, which will not be repeated here.

It should be understood that in actual applications, in order to be able to activate the functions provided or implemented by the second component based on different user needs, in the present disclosure, the user may also configure the activated function as needed, and control the availability of some or all of the functions that the second component can provide or realize based on the user's configured activated function.

More specifically, in the present disclosure, a functional state configuration table configured by the user for the second component may be obtained. The functional state configuration table may include at least one candidate function that the second component needs to activate.

For example, the functional state configuration table may include the activation state of each function supported by the first component. The activation state may include the activated state and the inactivated state. If the activation state of a certain function is not activated, the second component cannot provide or realize the function. On the contrary, if the activation state of a function supported by the second component is the activated state, the electronic device can provide or realize the function through the second component such that the function can be in an available state.

Based on this, based on the functional state configuration table, at least one candidate function in the second component can be set to the activated state such that when at least one candidate function includes the target function, the second component can be activated to provide or realize the target function.

It should be understood that if the target function does not belong to the candidate functions that need to be activated set in the functional state configuration table, the target function in the electronic device will be in an unavailable state, making it impossible for the second component to provide or realize the target function.

It should be understood that after the electronic device obtains the functional state configuration table, the functional state configuration table may be synchronized to the second component. Accordingly, the second component can control the target function to be in an available state or a disabled state based on the functional state configuration table.

However, when there is update information for the second component or the external operating system of the electronic device is started, the activation state of each function set by the user may be invalid due to reasons such as the functional state configuration table being invalid or bypassed.

Based on this, in order to ensure the effectiveness of the functional state configuration table, the electronic device may control the activation state of the target function and other functions in the second component based on the functional state configuration table. In the present disclosure, after obtaining the functional state configuration table, the functional state configuration table may be stored in the storage area of the first component. For example, the functional state configuration table may be stored in the storage area of the BIOS to effectively utilize the security of the storage area in the BIOS and reasonably control the activation or disabling of various functions corresponding to the second component.

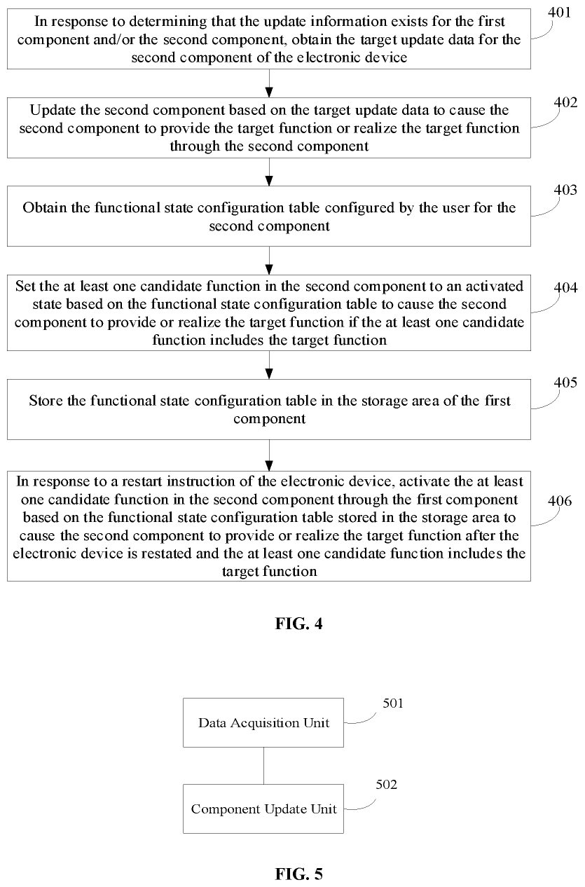

FIG. 4 is a flowchart of the update method according to an embodiment of the present disclosure. The method will be described in detail below.

401, in response to determining that the update information exists for the first component and/or the second component, obtaining the target update data for the second component of the electronic device.

402, updating the second component based on the target update data to cause the second component to provide the target function or realize the target function through the second component.

In some embodiments, the target update data may be associated with the update information.

For details of the processes at 401 and 402, reference can be made to the relevant description of the foregoing embodiments, which will not be repeated here.

403, obtaining the functional state configuration table configured by the user for the second component.

In some embodiments, the functional state configuration table may include at least one candidate function that the second component needs to activate.

It should be understood that the process at 403 may be executed after the process at 402. Considering that the user may configure the functional state configuration table at any time, the order of processes 403 and 402 may not be limited to the order shown in FIG. 4.

404, setting the at least one candidate function in the second component to an activated state based on the functional state configuration table to cause the second component to provide or realize the target function if the at least one candidate function includes the target function.

405, storing the functional state configuration table in the storage area of the first component.

It should be understood that after obtaining the functional state configuration table configured by the user, if the second component is not updated or the electronic device has not been restarted, the second component may control the activation or deactivation of various functions based on the functional state configuration table.

However, once the second component is updated or the electronic device is restarted, the functional state configuration table set in the second component will become invalid, or be bypassed in other ways without controlling the activation or deactivation of the corresponding functions of the second component based on the relevant configuration in the functional state configuration table.

In the present disclosure, after the functional state configuration table is stored in the storage area of the first component, even if the second component is updated or the electronic device is restarted, it will not affect the second component such that the functional state configuration table in the second component can still be valid.

It should be understood that the order of the processes 405 and 404 can be interchanged, or these two processes may be executed synchronously, which is not limited in the embodiments of the present disclosure.

406, in response to a restart instruction of the electronic device, activating the at least one candidate function in the second component through the first component based on the functional state configuration table stored in the storage area to cause the second component to provide or realize the target function after the electronic device is restated and the at least one candidate function includes the target function.

For example, after the electronic device is restarted, the first component may activate the corresponding candidate function in the second component based on its own stored functional state configuration table stored. Or, the management program may control the activation of the corresponding candidate function in the second component based on the functional state configuration table stored in the storage are of the first component.

Corresponding to the update method of the present disclosure, the present disclosure also provides an update device.

FIG. 5 is a schematic structural diagram of an update device according to an embodiment of the present disclosure. The update device of this embodiment can be applied to an electronic device, and the update device includes a data acquisition unit 501 and a component update unit 502. The data acquisition unit 501 may be configured to, in response to determining that the update information exists for the first component and/or the second component, obtain the target update data for the second component of the electronic device. The component update unit 502 may be configured to update the second component based on the target update data to cause the second component to provide the target function or realize the target function through the second component, the target update data having an association relationship with the update information.

In some embodiments, when determining that the update information exists for the first component and/or the second component, the data acquisition unit may be configured to: determine that the first update information exists for the first component and/or that the second update information exists for the second component in response to determining that the correspondence information between the first component and the second component of the electronic device does not match; determine that the first update information exists for the first component in response to determining that the current information of the first component of the electronic device does not match the corresponding historical information; determine that the second update information exists for the second component in response to determining that the current information of the second component of the electronic device does not match the corresponding historical information.

In some embodiments, when determining that the first update information exists for the first component, the data acquisition unit may be configured to determine that: the version update information exists for the first component; the flag bit update information exists for the first component, the flag bit update information being at least used to characterize the function item update information of the second component of the electronic device; there is a replacement record for the third component of the electronic device, the third component being used for the second component of the electronic device to achieve the target function. Alternatively, when determining that the second update information exists for the second component, the data acquisition unit may be configured to determine that: the version update information exists for the second component; the loading information exists for the second component; there is a replacement record for the third component of the electronic device, the third component being used for the second component of the electronic device to achieve the target function.

In some embodiments, the update device may also include a first prompt unit. The first prompt unit may be configured to output the target prompt information before the data acquisition unit obtains the target update data. The data acquisition unit may be configured to a data acquisition subunit. The data acquisition subunit may be configured to obtain the target update data after obtaining the target feedback information from the target user.

In some embodiments, the update device may also include a second prompt unit. The second prompt unit may be configured to output the target prompt information before updating the second component. The component update unit may include a component update subunit. The component update subunit may be configured to update the second component based on the target update data after obtaining the target feedback information from the target user.

In some embodiments, the first prompt unit and the second prompt unit may be configured to output the target prompt information in a target manner, the target manner being determined based on the update information.

In some embodiments, when obtaining the target update data of the second component of the electronic device, the data acquisition unit may be configured to: request the target update data matching the update information from the target server; obtain the acquisition path of the target update data based on the release information of the target update data to obtain the target update data based on the acquisition path; obtain the target update data of the second component pushed by the target server to the electronic device; obtain the target update data of the second component from an edge device that has established a target communication connection with the electronic device.

In some embodiments, the data acquisition unit may further include a function determination unit and a function data acquisition unit. The function determination unit may be configured to determine at least one target function to be set in the second component of the electronic device based on the flag bit information in the first component in response to determining that the update information exists for the first component and/or the second component, the flag bit information being used to record at least one function that the second component can have, and the target function belonging to the function recorded in the flag bit information. The function data acquisition unit may be configured to obtain the target update data for setting the target function.

In some embodiments, the function determination unit may include a function determination subunit. The function determination subunit may be configured to determine at least one target function to be set in the second component of the electronic device based on the flag bit information in the first component and the update information.

In some embodiments, the function determination subunit may include a first determination subunit and a second determination subunit. The first determination subunit may be configured to determine at least one new function added in the flag bit information of the first component, and determine the at least one new function as the at least one target function to be set in the second component in response to the update information being the first update information exists for the first component. The second determination subunit may be configured to determine at least one function recorded in the flag bit information of the first component as the at least one target function to be set by the second component in response to the update information being the second update information exists for the second component.

In some embodiments, the update device may further include a configuration acquisition unit and a function setting unit. The configuration acquisition unit may be configured to obtain the functional state configuration table configured by the user for the second component after the component update unit updates the second component. The functional state configuration table includes at least one candidate function that the second component needs to activate. The function setting unit may be configured to set the at least one candidate function in the second component to an activated state based on the functional state configuration table to enable the second component to provide or realize the target function if the at least one candidate function includes the target function.

Alternatively, the update device may further include a configuration storage unit and a function control unit. The configuration storage unit may be configured to store the functional state configuration table in the storage area of the first component after the configuration acquisition unit obtains the functional state configuration table configured by the user for the second component. The function control unit may be configured to, in response to a restart instruction of the electronic device, activate the at least one candidate function in the second component through the first component based on the functional state configuration table stored in the storage area of the first component to enable the second component to provide or realize the target function after the electronic device is restarted and the at least one candidate function includes the target function.

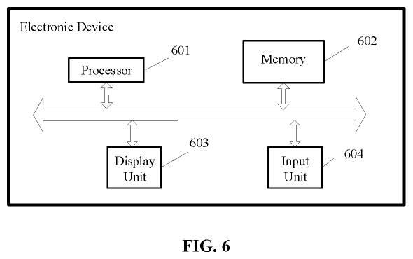

The present disclosure also provides an electronic device. FIG. 6 is a schematic structural diagram of an electronic device according to an embodiment of the present disclosure. The electronic device can be any type of electronic devices. As shown in FIG. 6, the electronic device at least includes a processor 601 and a memory 602. The processor 601 is configured to perform the update method of any of the previously described embodiments. The memory 602 is configured to store programs needed for the processor 602 to perform operations.

It should be understood that the electronic device may also include a display unit 603 and an input unit 604.

Of course, the electronic device may also have more or fewer components than in FIG. 6, which is not limited in the embodiments of the present disclosure.

The present disclosure also provides a computer-readable storage medium. The computer-readable storage medium stores at least one instruction, at least one program, code set, or instruction set. At least one instruction, at least one program, the code set, or instruction set is loaded and executed by a processor to perform the update method in any one of the above-described embodiments.

The present disclosure also provides a computer program. The computer program includes computer instructions. The computer instructions are stored in a computer-readable storage medium. When the computer program runs on an electronic device, the computer program is used to perform the update method in any one of the above-described embodiments.

The terms such as “first,” “second,” “third,” “fourth,” and the like in the specification and in the claims, if any, are used for distinguishing similar elements and not necessarily for describing a particular sequential or chronological order. It can be understood that the terms so used are interchangeable under appropriate circumstances such that the embodiments of the present disclosure herein are capable of operation in sequences other than those illustrated or described herein.

It should be noted that each embodiment in this specification is described in a progressive manner, and each embodiment focuses on the differences from other embodiments. For the same and similar parts in each embodiment, reference can be made to each other. At the same time, the features described in various embodiments in this specification may be replaced or combined with each other, such that those skilled in the art can implement or use the present disclosure. As for the device-type embodiments, because they are basically similar to the method embodiments, the description thereof is relatively simple. For details of related parts, reference can be made to the description of the method embodiments.

Further, it should also be noted that in this specification, relational terms such as first and second etc. are only used to distinguish one entity or operation from another, and do not necessarily require or imply that any such actual relationship or order of these entities or operations exists. The terms “includes,” “comprises” or any other variation thereof are intended to cover a non-exclusive inclusion such that a process, method, article, or apparatus comprising a set of elements includes not only those elements, but also includes elements not expressly listed. or also includes elements inherent in such a process, method, article, or apparatus. Without further limitations, an element defined by the phrase “comprising a . . . ” does not preclude the presence of additional identical elements in the process, method, article, or apparatus that includes the element.

The above description of the disclosed embodiments is provided to enable those skilled in the art to make or use the present disclosure. Various modifications to these embodiments will be readily apparent to those skilled in the art, and the general principles defined herein may be implemented in other embodiments without departing from the spirit or scope of the present disclosure. Therefore, the present disclosure will not be limited to the embodiments shown herein, but is to be accorded the widest scope consistent with the principles and novel features disclosed herein.

The embodiments disclosed herein are merely examples. Other applications, advantages, alternations, or modifications of, or equivalents to the disclosed embodiments are obvious to a person skilled in the art and are intended to be encompassed within the scope of the present disclosure.

What is claimed is:

1. An update method comprising:
in response to determining that update information exists for a first component and/or a second component of an electronic device, obtaining target update data for the second component of the electronic device; and
updating the second component based on the target update data to cause the second component to provide a target function or realize the target function through the second component, wherein:
the target update data has an association relationship with the update information.

2. The method of claim 1, wherein determining that the update information exists for the first component and/or the second component of the electronic device includes at least one of:
determining that first update information exists for the first component and/or second update information exists for the second component in response to determining that correspondence information between the first component and the second component of the electronic device does not match;
determining that the first update information exists for the first component in response to determining that current information of the first component of the electronic device does not match corresponding historical information; or,
determining that the second update information exists for the second component in response to determining that current information of the second component of the electronic device does not match corresponding historical information.

3. The method of claim 2, wherein determining that the first update information exists for the first component includes that:
version update information exists for the first component;
flag bit update information exists for the first component, the flag bit update information being at least used to characterize function item update information of the second component of the electronic device; or
a replacement record exists for a third component of the electronic device, the third component being used for the second component of the electronic device to achieve the target function; or,
determining that the second update information exists for the second component includes that:
the version update information exists for the second component;
loading information exists for the second component; or
the replacement record exists for the third component, the third component being used by the second component to achieve the target function.

4. The method of claim 1 further comprising at least one of:
outputting target prompt information, and obtaining the target update data after obtaining target feedback information from a target user;
outputting the target prompt information, and updating the second component based on the target update data after obtaining the target feedback information from the target user; or
outputting the target prompt information in a target manner, and obtaining the target update data or updating the second component based on the target update data after obtaining the target feedback information from the target user, the target manner being determined based on the update information.

5. The method of claim 1, wherein obtaining the target update data of the second component of the electronic device includes at least one of:
requesting target update data matching the update information from a target server;
obtaining an acquisition path of the target update data based on release information of the target update data to obtain the target update data based on the acquisition path;
obtaining the target update data of the second component pushed by the target server to the electronic device; or
obtaining the target update data of the second component from an edge device that has established a target communication connection with the electronic device.

6. The method of claim 1, wherein obtaining the target update data of the second component includes:
determining at least one target function to be set in the second component of the electronic device based on flag bit information in the first component, the flag bit information being used to record at least one function that the second component can have, the target function belonging to the function recorded in the flag bit information; and
obtaining the target update data for setting the target function.

7. The method of claim 6, wherein determining the at least one target function to be set in the second component of the electronic device based on the flag bit information in the first component include:
determining the at least one target function to be set in the second component of the electronic device based on the flag bit information and the update information.

8. The method of claim 7, wherein determining the at least one target function to be set in the second component of the electronic device based on the flag bit information and the update information includes:
determining at least one new function added in the flag bit information of the first component, and determining the at least one new function as the at least one target function to be set in the second component when the update information is that the first update information exists for the first component; and
determining at least one function recorded in the flag bit information of the first component as the at least one target function to be set by the second component when the update information is that the second update information exists for the second component.

9. The method of claim 1, after updating the second component based on the target update data further comprising:
obtaining a functional state configuration table configured by a user for the second component, the functional state configuration table including at least one candidate function that the second component needs to activate;
setting the at least one candidate function in the second component to an activate state based on the functional state configuration table to cause the second component to provide or realize the target function if the at least one candidate function includes the target function;
storing the functional state configuration table in a storage area of the first component;
in response to a restart instruction of the electronic device, activating the at least one candidate function in the second component through the first component based on the functional state configuration table stored in the storage area of the first component to cause the second component to provide or realize the target function after the electronic device is restarted and the at least one candidate function includes the target function.

10. An update device comprising:
a data acquisition unit being configured to, in response to determining that update information exists for a first component and/or a second component of an electronic device, obtain target update data of the second component of the electronic device; and
a component update unit being configured to update the second component based on the target update data to cause the second component to provide a target function or realize the target function through the second component, wherein:
the target update data has an association relationship with the update information.

11. The device of claim 10, wherein when determining that the update information exists for the first component and/or the second component of the electronic device, the data acquisition unit is configured to perform at least one of:
determining that first update information exists for the first component and/or second update information exists for the second component in response to determining that correspondence information between the first component and the second component of the electronic device does not match;
determining that the first update information exists for the first component in response to determining that current information of the first component of the electronic device does not match corresponding historical information; or
determine determining that the second update information exists for the second component in response to determining that current information of the second component of the electronic device does not match corresponding historical information.

12. The device of claim 11, wherein when determining that the first update information exists for the first component, the data acquisition unit is configured to determine that:
version update information exists for the first component;
flag bit update information exists for the first component, the flag bit update information being at least used to characterize function item update information of the second component of the electronic device; or
a replacement record exists for a third component of the electronic device, the third component being used for the second component of the electronic device to achieve the target function; or,
when determining that the second update information exists for the second component, the data acquisition unit is configured to determine that:
the version update information exists for the second component;
loading information exists for the second component; or
the replacement record exists for the third component, the third component being used by the second component to achieve the target function.

13. The device of claim 10, wherein when obtaining the target update data of the second component of the electronic device, the data acquisition unit is configured to perform at least one of:
requesting target update data matching the update information from a target server;
obtaining an acquisition path of the target update data based on release information of the target update data to obtain the target update data based on the acquisition path;
obtaining the target update data of the second component pushed by the target server to the electronic device; or
obtaining the target update data of the second component from an edge device that has established a target communication connection with the electronic device.

14. A non-transitory computer-readable storage medium containing computer-executable instructions for, when executed by one or more processors, performing an update method, the method comprising:
updating the second component based on the target update data to cause the second component to provide a target function or realize the target function through the second component, wherein:
the target update data has an association relationship with the update information.

15. The non-transitory computer-readable storage medium of claim 14, wherein determining that the update information exists for the first component and/or the second component of the electronic device includes at least one of:
determining that first update information exists for the first component and/or second update information exists for the second component in response to determining that correspondence information between the first component and the second component of the electronic device does not match;
determining that the first update information exists for the first component in response to determining that current information of the first component of the electronic device does not match corresponding historical information; or
determining that the second update information exists for the second component in response to determining that current information of the second component of the electronic device does not match corresponding historical information.

16. The non-transitory computer-readable storage medium of claim 15, wherein determining that the first update information exists for the first component includes that:
version update information exists for the first component;
flag bit update information exists for the first component, the flag bit update information being at least used to characterize function item update information of the second component of the electronic device; or
a replacement record exists for a third component of the electronic device, the third component being used for the second component of the electronic device to achieve the target function; or,
determining that the second update information exists for the second component includes that:
the version update information exists for the second component;
loading information exists for the second component; or
the replacement record exists for the third component, the third component being used by the second component to achieve the target function.

17. The non-transitory computer-readable storage medium of claim 14, wherein the method further comprising at least one of:
outputting target prompt information, and obtaining the target update data after obtaining target feedback information from a target user;
outputting the target prompt information, and updating the second component based on the target update data after obtaining the target feedback information from the target user; or
outputting the target prompt information in a target manner, and obtaining the target update data or updating the second component based on the target update data after obtaining the target feedback information from the target user, the target manner being determined based on the update information.

18. The non-transitory computer-readable storage medium of claim 14, wherein obtaining the target update data of the second component of the electronic device includes at least one of:
requesting target update data matching the update information from a target server;
obtaining an acquisition path of the target update data based on release information of the target update data to obtain the target update data based on the acquisition path;
obtaining the target update data of the second component pushed by the target server to the electronic device; or
obtaining the target update data of the second component from an edge device that has established a target communication connection with the electronic device.

19. The non-transitory computer-readable storage medium of claim 14, wherein obtaining the target update data of the second component includes:
determining at least one target function to be set in the second component of the electronic device based on flag bit information in the first component, the flag bit information being used to record at least one function that the second component can have, the target function belonging to the function recorded in the flag bit information; and
obtaining the target update data for setting the target function.

20. The non-transitory computer-readable storage medium of claim 19, wherein determining the at least one target function to be set in the second component of the electronic device based on the flag bit information in the first component include:
determining the at least one target function to be set in the second component of the electronic device based on the flag bit information and the update information.
